(19) United States
(12) Patent Application Publication
(10) Pub. No.: US 2009/0281956 A1
(43) Pub. Date: Nov. 12, 2009

(54) METHOD AND SYSTEM FOR ENTERPRISE PORTFOLIO OPTIMIZATION

(75) Inventors: Lianjun An, Yorktown Heights, NY (US); Daniel E. Benoit, Stamford, CT (US); Blair Binney, Marlboro, NY (US); Pawan Raghunath Chowdhary, Montrose, NY (US); Pu Huang, Yorktown Heights, NY (US); Dharmashankar Subramanian, Tarrytown, NY (US); Julian Ybarra, Greenwich, CT (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 12/117,793

(22) Filed: May 9, 2008

(51) Int. Cl. G06Q 40/00

(52) U.S. Cl. 705/36 R

(57) ABSTRACT

A portfolio generating system includes a portfolio optimizing unit configured to generate an optimized portfolio.

### BACKGROUND OF THE INVENTION

1. Field of the Invention

The present invention generally relates to portfolio optimization, and more particular to a method (and system) for enterprise portfolio optimization that enables decision makers to select an optimal portfolio from multiple projects.

2. Description of the Related Art

Today's increasingly competitive market is driving companies to continuously invest in projects that are designed to improve performance and to fully maximize the value of their project portfolios. To maintain a healthy mix of projects, an enterprise must optimize their portfolios constantly in response to an ever-changing competition landscape. To get the maximum value out of limited resources, companies need to decide which projects to commit to, and optimally allocate funding to them (a decision often referred to as “enterprise portfolio optimization”). Deciding which projects to fund is a complicated strategic decision that affects the final value a company can finally deliver.

Within a large enterprise, portfolio selection often involves multiple stakeholders with different, sometime even conflicting, goals. The goals of each stakeholder must be balanced under a variety of physical and/or business constraints. These constraints include, but are not limited to, budget, resources, project dependence, business rules, etc.

A typical approach to enterprise portfolio optimization is to draw an analogy between project portfolios and investment portfolios consisting of financial securities, and try to apply the methods developed for investment optimization, e.g., Markowitz's efficient frontier method and its various extensions, to project selection.

### SUMMARY OF THE INVENTION

Applicants' have discovered, however, that directly applying the typical methods to optimize enterprise project portfolios is often impractical due to the following reasons.

Firstly, companies might need to consider portfolio performance metrics other than merely risk and return, which typically are the only two metrics an investment portfolio concerns. For example, a company might want to fund a project that boosts customer satisfaction, even though it may not directly yield any tangible financial returns.

Secondly, companies often have to obey various business rules when making the portfolio decisions, while typical investment portfolio optimization methods do not handle these rules. For example, a company might have to invest at least 10% of its budgets on marketing projects as dictated by its business strategy.

Thirdly, projects may be connected to each other through a complex precedence relation, which restrict the final portfolio one can possibly create. For example, a project A may be dependent on another project B and thus one can not create a portfolio including A without B. Investment portfolio optimization methods typically cannot deal with this type of dependence.

Fourthly, limitations on resources other than budget might restrict portfolio selection as well, while investment optimization is typically restricted only by budget. For example, a limited number of people with a special skill required by many projects will affect the final portfolio decision.

To summarize, it is beyond the ability of the typical approaches to take into account all of the physical and/or business constraints (i.e., budget, resources, project dependence, business rules, etc.) when making enterprise portfolio decisions.

In view of the foregoing and other exemplary problems, drawbacks, and disadvantages of the conventional methods and structures, an exemplary feature of the present invention is to provide a method and system that overcomes these disadvantages.

In a first exemplary, non-limiting aspect of the present invention, a portfolio generating system includes a portfolio optimizing unit configured to generate an optimized portfolio.

In a second exemplary, non-limiting aspect of the present invention, a method of generating a portfolio includes optimizing input parameters to generate an optimized portfolio.

In a third exemplary, non-limiting aspect of the present invention, a computer-readable medium tangibly embodies a program of computer-readable instructions executable by a digital processing apparatus to perform a method of generating a portfolio, where the method includes optimizing input parameters to generate an optimized portfolio.

These and many other advantages may be achieved with the present invention.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 illustrates exemplary inputs 110 and outputs 130 using a system (method) 100 in accordance with an exemplary, non-limiting embodiment of the present invention;

FIG. 2 illustrates a portfolio optimization method 200 in accordance with an exemplary, non-limiting embodiment of the present invention;

FIG. 3 illustrates an exemplary hardware/information handling system 300 for incorporating an exemplary, non-limiting embodiment of the present invention therein; and

FIG. 4 illustrates a signal bearing medium 400 (e.g., computer readable storage medium) for storing steps of a program of a method according to an exemplary, non-limiting embodiment of the present invention.

### DETAILED DESCRIPTION OF EXEMPLARY EMBODIMENTS OF THE INVENTION

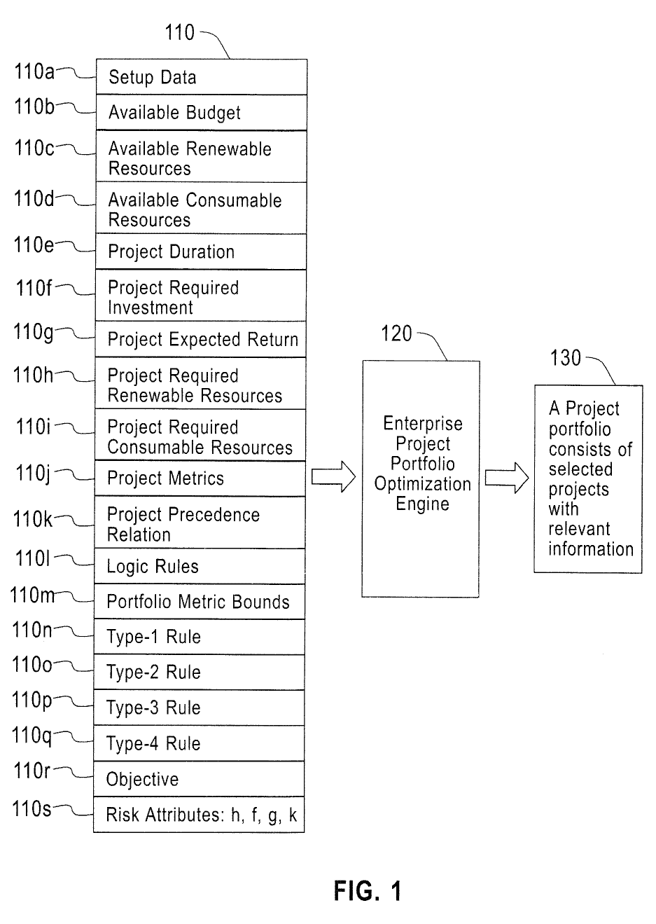

Referring now to the drawings, and more particularly to FIGS. 1-4, there are shown exemplary embodiments of the method and structures of the present invention.

In the following discussion, the method and system of the present invention is described with respect to enterprise portfolio optimization. The present method and system, however, may be used for any decision optimization where a decision is being made based on one or more input parameters from one or more users (i.e., decision-makers).

In accordance with certain exemplary, non-limiting embodiments of the present invention, a portfolio optimization system (and method) includes a computer-implemented optimization engine that takes input including, but not necessarily limited to, multiple user-defined metrics, multiple user-defined resources and their availability, multiple project candidates, multiple business rules, project precedence relation, and user's risk attitude. Based on these inputs, the optimization engine generates an optimal (e.g., balanced) portfolio.

The system (method) of the present invention can handle arbitrary numbers of user-defined, time-phased metrics and recommend a portfolio to optimize them all jointly. Examples of metrics include, but are not limited to, strategy alignment, total revenue, customer satisfaction, cycle time, etc. Furthermore, project required investment and project expected return can be implemented as default metrics.

The system (method) of the presented invention allows a user to define arbitrary time-phased resource constraints and the optimizer can optimally schedule projects based on their resource consumption profiles.

The system (method) of the presented invention can also handle varying types of business rules. Examples of business rules include, “at least 20% of the total investment should be allocated to the short-term research projects”, “all marketing projects should be selected”, “if project A is chosen, so is project B”, “if project A is chosen, it can not start later than July 2007”, etc.

The system (method) can handle an arbitrary project precedence structure.

FIG. 1 presents exemplary inputs 110, which are input into an optimization engine 120, and outputs 130 of the method/system 100 of the present invention. Inputs 110 are grouped into categories for presentation clarity. Outputs 130 from the method/system 100 include the optimal project portfolio computed based on the inputs 110. Inputs 110 can be either deterministic or random quantities. For purposes of the following discussion, a quantity is deterministic unless specifically identified as random.

The “Setup Data” 110a category includes five inputs: T, P, M, R, and J. T is the maximum number of time periods in the planning horizon, T≧1. P is the number of projects to consider, P≧1. M is the number of user-defined metrics, M≧0. R is the number of user-defined renewable resources (a type of resource where the amount left over in a proceeding period is not available to the next period), R≧0. J is the number of user-defined consumable resources (a type of resource where the amount left over in a proceeding period is available to the next period), J≧0.

The “Available Budget” 110b category includes T inputs: Eₜ, t=1,2, . . . ,T, representing the available budget in each period from 1 to T.

If R is zero, no “Available Renewable Resources” 110c inputs are needed. Otherwise, this category includes R×T (R multiplied by T) inputs: H_{r,t}, r=1,2, . . . ,R, t=1,2, . . . ,T, representing the available amount of the r-th renewable resource in each period from 1 to T.

If J is zero, no “Available Consumable Resources” 110d inputs are needed. Otherwise, this category includes J×T inputs: G_{j,t}, j=1,2, . . . ,J, t=1,2, . . . ,T, representing the available amount of the j-th consumable resource in each period from 1 to T.

The “Project Duration” 110e category includes P inputs: Sₚ, p=1,2, . . . ,P, representing the duration of the p-th project. One may not know for sure how long a project will last. If this is the case, Sₚ can be treated as a random quantity, and the user is required to input the following information of Sₚ: the minimum duration Lₚ≧1, the maximum duration Uₚ≦T, and for each possible duration value eε[Lₚ, Uₚ], the probability q_{p,e} that the p-th project will last for e periods. Since q_{p,e} is a probability distribution so that,

$${\sum }_{e = {L}_{p}}^{{U}_{p}} {q}_{p , e} = 1 ∀ p = 1 , 2 , … , P . \qquad ( 1 )$$

The “Project Required Investment” 110f category includes P groups of inputs, and each group contains Uₚ inputs. Let ã_{p,s}, p=1,2, . . . ,P, s=1,2, . . . ,Uₚ denote these inputs. For 1≦s≦Lₚ, ã_{p,s}, is the required investment of project p in its first Lₚ periods (project p will last for at least Lₚ periods). ã_{p,L}_{ₚ}₊₁ is the additional investment required in the (Lₚ+1)-th period (relative to the starting period of project p) if project p lasts for Lₚ+1 periods; ã_{p,L}_{ₚ}₊₂ is the further additional investment required in the (Lₚ+2)-th period (relative to the starting period of project p) if project p lasts for Lₚ+2 periods; and so on. One may not know for sure how much investment is needed for a project in each period. If this is the case, ã_{p,s}, is a random quantity and the user inputs the following information: the mean value μ(ã_{p,s}) and the variance σ(ã_{p,s}) of ã_{p,s}.

The “Project Expected Return” 110g category includes P groups of inputs, and each group contains T×(Uₚ−Lₚ+1) inputs. Let \tilde{b}_{p,s,e}, p=1,2, . . . ,P, s=1,2, . . . ,T, e=Lₚ,Lₚ+1, . . . ,Uₚ, denote these inputs. \tilde{b}_{p,s,L}_{ₚ} is the expected return of project p in each period s from 1 to T if it lasts for Lₚ periods; \tilde{b}_{p,s,L}_{ₚ}₊₁ the expected return of project p in each period s from 1 to T if it lasts for Lₚ+1 periods; and so on. A user may not know a project's expected return. If this is the case, then \tilde{b}_{p,s,e} is a random quantity and the user inputs the following information: the mean value μ(\tilde{b}_{p,s,e}) and the variance σ(\tilde{b}_{p,s,e}) of \tilde{b}_{p,s,e}. Note that s is a relative time index, s=1 is the first period of a project; s=2 is the second period, and so on. Since a project may generate returns after its completion, index s is allowed to exceed the maximum project duration Uₚ. Index s is bounded by the maximum planning horizon T.

If R is zero, no “Project Required Renewable Resources” 110h inputs are needed. Otherwise, this category includes P×R groups of inputs, and each group contains Uₚ inputs. Let \tilde{c}_{p,r,s}, p=1,2, . . . ,P, r=1,2, . . . ,R, s=1,2, . . . ,Uₚ denote these inputs. For 1≦s≦Lₚ, \tilde{c}_{p,r,s} is the r-th renewable resource required by project p in its first Lₚ periods (project p will last for at least Lₚ periods); \tilde{c}_{p,r,L}_{ₚ}₊₁ is the additional r-th renewable resource required in the Lₚ+1 period (relative to the starting period of project p) if project p lasts for Lₚ+1 periods; and \tilde{c}_{p,r,L}_{ₚ}₊₂ is the further additional r-th renewable resource required in the Lₚ+2 period (relative to the starting period of project p) if project p lasts for Lₚ+2 periods, and so on. One may not know for sure how much renewable resource is needed for a project. If this is the case, then \tilde{c}_{p,r,s} is a random quantity and the user inputs the following information: the mean value μ(\tilde{c}_{p,r,s}), and the variance σ(\tilde{c}_{p,r,s}) of \tilde{c}_{p,r,s}.

If J is zero, then no “Project Required Consumable Resources” 110i inputs are needed. Otherwise, this category includes P×J groups of inputs, and each group contains Uₚ inputs. Let \tilde{d}_{p,j,s}, p=1,2, . . . ,P, j=1,2, . . . ,J, s=1,2, . . . ,Uₚ denote these inputs. For 1≦s≦Lₚ, \tilde{d}_{p,j,s} is the j-th consumable resource required by project p in its first Lₚ periods (project p will last for at least Lₚ periods); \tilde{d}_{p,j,L}_{ₚ}₊₁ is the additional j-th consumable resource required in the Lₚ+1 period (relative to the starting period of project p) if project p lasts for Lₚ+1 periods; and \tilde{d}_{p,j,L}_{ₚ}₊₂ is the further additional j-th consumable resource required in the Lₚ+2 period (relative to the starting period of project p) if project p lasts for Lₚ+2 periods, and so on. A user may not know how much consumable resource is needed for a project. If this is the case, then \tilde{d}_{p,j,s} is a random quantity and the user inputs the following information: the mean value μ(\tilde{d}_{p,j,s}), and the variance σ(\tilde{d}_{p,j,s}), of \tilde{d}_{p,j,s}.

If M is zero, no “Project Metrics” 110j inputs are needed. Otherwise, this category includes P×M groups of inputs, and each group contains T×(Uₚ−Lₚ+1) inputs. Let \tilde{v}_{p,m,s,e}, p=1,2, . . . ,P, m=1,2, . . . ,M, s=1,2, . . . ,T, e=Lₚ,Lₚ+1, . . . ,Uₚ denote these inputs. \tilde{v}_{p,m,s,L}_{ₚ} is the contribution of project p to metric m in each period s (relative to the starting time) if it lasts for Lₚ periods; \tilde{v}_{p,m,s,L}_{ₚ}₊₁ is the contribution of project p to metric m in each period s (relative to the starting period of project p) if it lasts for Lₚ+1 periods; and so on. One may not know how much a project will contribute to a certain metric. If this is the case, then \tilde{v}_{p,m,s,e} is a random quantity and the user inputs the following information: the mean value μ(\tilde{v}_{p,m,s,e}), and the variance σ(\tilde{v}_{p,m,s,e}), of \tilde{v}_{p,m,s,e}. Note that just as in “Project Expected Return”, relative index s is allowed to exceed the maximum project duration.

Based on the inputs of “Setup Data” 110a, “Available Budget” 110b, “Available Renewable Resources” 110c, “Available Consumable Resources” 110d, “Project Duration” 110e, “Project Required Investment” 110f, “Project Expected Return” 110g, “Project Required Renewable Resources” 110h, “Project Required Consumable Resources” 110i, and “Project Metrics” 110j, a set of constraints are constructed, which represent the restrictions one has to consider when computing the optimal project portfolio.

Before creating these constraints, a few inputs are transformed into another form that the system/method will accept. These inputs include ã_{p,s}, p=1,2, . . . ,P, s=1,2, . . . ,Uₚ (from category “Project Required Investment” 110f), \tilde{b}_{p,s,e}, p=1,2, . . . ,P s=1,2, . . . ,T, e=Lₚ,Lₚ+1, . . . ,Uₚ (from category “Project Expected Return” 110g), \tilde{c}_{p,r,s}, p=1,2, . . . ,P, r=1,2, . . . ,R, s=1,2, . . . ,Uₚ (from category “Project Required Renewable resources” 110h if R is not zero), \tilde{d}_{p,j,s}, p=1,2, . . . ,P, j=1,2, . . . ,J, s=1,2, . . . Uₚ (from category “Project Required Consumable Resources” 110i if J is not zero), and \tilde{v}_{p,m,s,e}, p=1,2, . . . ,P, m=1,2, . . . ,M, s=1,2, . . . ,T, e=Lₚ,Lₚ+1, . . . ,Uₚ (from category “Project Metrics” 110j if M is not zero).

ã_{p,s} is transformed to a_{p,s} using the following formula.

$${a}_{p , s} = {\tilde{a}}_{p , s} , s ∈ [ 1 , {L}_{p} ] \\ {a}_{p , {L}_{p} + 1} = ( {q}_{p , {L}_{p} + 1} + {q}_{p , {L}_{p} + 2} + … + {q}_{p , {U}_{p}} ) {\tilde{a}}_{p , {L}_{p} + 1} \\ {a}_{p , {L}_{p} + 2} = ( {q}_{p , {L}_{p} + 2} + … + {q}_{p , {U}_{p}} ) {\tilde{a}}_{p , {L}_{p} + 2} \\ ⋯ \\ {a}_{p , {U}_{p}} = {q}_{p , {U}_{p}} {\tilde{a}}_{p , {U}_{p}} \qquad ( 2 )$$

where q_{p,e}, p=1,2, . . . ,P, e=Lₚ,Lₚ+1, . . . ,Uₚ, is defined in (1). ã_{p,s} is the conditional investment requirement (conditioned on how many periods a project will last), where a_{p,s} is the unconditional investment requirement, which is the input form our method accepts. From transformation formula (2), the mean value μ(a_{p,s}) is calculated and the variance σ(a_{p,s}) of a_{p,s} is calculated as

$$\begin{matrix}μ ( {a}_{p , s} ) = μ ( {\tilde{a}}_{p , s} ) , s ∈ [ 1 , {L}_{p} ] \\ μ ( {a}_{p , {L}_{p} + 1} ) = ( {q}_{p , {L}_{p} + 1} + {q}_{p , {L}_{p} + 2} + … + {q}_{p , {U}_{p}} ) μ ( {\tilde{a}}_{p , {L}_{p} + 1} ) \\ μ ( {a}_{p , {L}_{p} + 2} ) = ( {q}_{p , {L}_{p} + 2} + … + {q}_{p , {U}_{p}} ) μ ( {\tilde{a}}_{p , {L}_{p} + 2} ) \\ ⋯ \\ μ ( {a}_{p , {U}_{p}} ) = {q}_{p , {U}_{p}} μ ( {\tilde{a}}_{p , {U}_{p}} ) \\ and & ( 3 ) \\ σ ( {a}_{p , s} ) = σ ( {\tilde{a}}_{p , s} ) , s ∈ [ 1 , {L}_{p} ] \\ σ ( {a}_{p , {L}_{p} + 1} ) = {( {q}_{p , {L}_{p} + 1} + {q}_{p , {L}_{p} + 2} + … + {q}_{p , {U}_{p}} )}^{2} σ ( {\tilde{a}}_{p , {L}_{p} + 1} ) \\ σ ( {a}_{p , {L}_{p} + 2} ) = {( {q}_{p , {L}_{p} + 2} + … + {q}_{p , {U}_{p}} )}^{2} σ ( {\tilde{a}}_{p , {L}_{p} + 2} ) \\ ⋯ \\ σ ( {a}_{p , {U}_{p}} ) = {q}_{p , {U}_{p}}^{2} σ ( {\tilde{a}}_{p , {U}_{p}} ) & ( 4 )\end{matrix}$$

\tilde{b}_{p,s,e} is transformed to b_{p,s} using the following formula.

$${b}_{p , s} = {\sum }_{e = {L}_{p}}^{{U}_{p}} {q}_{p , e} {\tilde{b}}_{p , s , e} ∀ p = 1 , 2 , … , P , s = 1 , 2 , … , T , \qquad ( 5 )$$

where q_{p,e}, p=1,2, . . . ,P, e=Lₚ, Lₚ+1, . . . Uₚ is defined in (1). \tilde{b}_{p,s,e} is the conditional expected return (conditioned on how many periods a project will last), where b_{p,s} is the unconditional expected return, which is the input form our method accepts. From transformation formula (5), the mean value μ(b_{p,s}) and the variance σ(b_{p,s}) of b_{p,s} are calculated as

$$\begin{matrix}μ ( {b}_{p , s} ) = {\sum }_{e = {L}_{p}}^{{U}_{p}} {q}_{p , e} μ ( {\tilde{b}}_{p , s , e} ) \\ and & ( 6 ) \\ σ ( {b}_{p , s} ) = {\sum }_{e = {L}_{p}}^{{U}_{p}} {q}_{p , e}^{2} σ ( {\tilde{b}}_{p , s , e} ) . & ( 7 )\end{matrix}$$

\tilde{c}_{p,r,s} is transformed to c_{p,r,s} using the following formula.

$${c}_{p , r , s} = {\tilde{c}}_{p , r , s} , s ∈ [ 1 , {L}_{p} ] \\ {c}_{p , r , {L}_{p} + 1} = ( {q}_{p , {L}_{p} + 1} + {q}_{p , {L}_{p} + 2} + … + {q}_{p , {U}_{p}} ) {\tilde{c}}_{p , r , {L}_{p} + 1} \\ {c}_{p , r , {L}_{p} + 2} = ( {q}_{p , {L}_{p} + 2} + … + {q}_{p , {U}_{p}} ) {\tilde{c}}_{p , r , {L}_{p} + 2} \\ ⋯ \\ {c}_{p , r , {U}_{p}} = {q}_{p , {U}_{p}} {\tilde{c}}_{p , r , {U}_{p}} \qquad ( 8 )$$

where q_{p,e}, p=1,2, . . . ,P, e=Lₚ,Lₚ+1, . . . ,Uₚ, is defined in (1). From transformation formula (8), the mean value μ(c_{p,r,s}) and the variance σ(c_{p,r,s}) of c_{p,r,s} are calculated as

$$\begin{matrix}μ ( {c}_{p , r , s} ) = μ ( {\tilde{c}}_{p , r , s} ) , s ∈ [ 1 , {L}_{p} ] \\ μ ( {c}_{p , r , {L}_{p} + 1} ) = ( {q}_{p , {L}_{p} + 1} + {q}_{p , {L}_{p} + 2} + … + {q}_{p , {U}_{p}} ) μ ( {\tilde{c}}_{p , r , {L}_{p} + 1} ) \\ μ ( {c}_{p , r , {L}_{p} + 2} ) = ( {q}_{p , {L}_{p} + 2} + … + {q}_{p , {U}_{p}} ) μ ( {\tilde{c}}_{p , r , {L}_{p} + 2} ) \\ ⋯ \\ μ ( {c}_{p , r , {U}_{p}} ) = {q}_{p , {U}_{p}} μ ( {\tilde{c}}_{p , r , {U}_{p}} ) \\ and & ( 9 ) \\ σ ( {c}_{p , r , s} ) = σ ( {\tilde{c}}_{p , r , s} ) , s ∈ [ 1 , {L}_{p} ] \\ σ ( {c}_{p , r , {L}_{p} + 1} ) = {( {q}_{p , {L}_{p} + 1} + {q}_{p , {L}_{p} + 2} + … + {q}_{p , {U}_{p}} )}^{2} σ ( {\tilde{c}}_{p , r , {L}_{p} + 1} ) \\ σ ( {c}_{p , r , {L}_{p} + 2} ) = {( {q}_{p , {L}_{p} + 2} + … + {q}_{p , {U}_{p}} )}^{2} σ ( {\tilde{c}}_{p , r , {L}_{p} + 2} ) \\ ⋯ \\ σ ( {c}_{p , r , {U}_{p}} ) = {q}_{p , {U}_{p}}^{2} σ ( {\tilde{c}}_{p , r , {U}_{p}} ) & ( 10 )\end{matrix}$$

\tilde{d}_{p,j,s} is transformed to d_{p,j,s} using the following formula.

$${d}_{p , j , s} = {\tilde{d}}_{p , j , s} , s ∈ [ 1 , {L}_{p} ] \\ {d}_{p , j , {L}_{p} + 1} = ( {q}_{p , {L}_{p} + 1} + {q}_{p , {L}_{p} + 2} + … + {q}_{p , {U}_{p}} ) {\tilde{d}}_{p , j , {L}_{p} + 1} \\ {d}_{p , j , {L}_{p} + 2} = ( {q}_{p , {L}_{p} + 2} + … + {q}_{p , {U}_{p}} ) {\tilde{d}}_{p , j , {L}_{p} + 2} \\ ⋯ \\ {d}_{p , j , {U}_{p}} = {q}_{p , {U}_{p}} {\tilde{d}}_{p , j , {U}_{p}} \qquad ( 11 )$$

where q_{p,e}, p=1,2, . . . ,P, e=Lₚ,Lₚ+1, . . . ,Uₚ, is defined in (1). From transformation formula (11), the mean μ(d_{p,j,s}) and the variance σ(d_{p,j,s}) of d_{p,j,s} are calculated as

$$\begin{matrix}μ ( {d}_{p , j , s} ) = μ ( {\tilde{d}}_{p , j , s} ) , s ∈ [ 1 , {L}_{p} ] \\ μ ( {d}_{p , j , {L}_{p} + 1} ) = ( {q}_{p , {L}_{p} + 1} + {q}_{p , {L}_{p} + 2} + … + {q}_{p , {U}_{p}} ) μ ( {\tilde{d}}_{p , j , {L}_{p} + 1} ) \\ μ ( {d}_{p , j , {L}_{p} + 2} ) = ( {q}_{p , {L}_{p} + 2} + … + {q}_{p , {U}_{p}} ) μ ( {\tilde{d}}_{p , j , {L}_{p} + 2} ) \\ ⋯ \\ μ ( {d}_{p , j , {U}_{p}} ) = {d}_{p , {U}_{p}} μ ( {\tilde{d}}_{p , j , {U}_{p}} ) \\ and & ( 12 ) \\ σ ( {d}_{p , r , s} ) = σ ( {\tilde{d}}_{p , j , s} ) , s ∈ [ 1 , {L}_{p} ] \\ σ ( {d}_{p , j , {L}_{p} + 1} ) = {( {q}_{p , {L}_{p} + 1} + {q}_{p , {L}_{p} + 2} + … + {q}_{p , {U}_{p}} )}^{2} σ ( {\tilde{d}}_{p , j , {L}_{p} + 1} ) \\ σ ( {d}_{p , j , {L}_{p} + 2} ) = {( {q}_{p , {L}_{p} + 2} + … + {q}_{p , {U}_{p}} )}^{2} σ ( {\tilde{d}}_{p , j , {L}_{p} + 2} ) \\ ⋯ \\ σ ( {d}_{p , j , {U}_{p}} ) = {q}_{p , {U}_{p}}^{2} σ ( {\tilde{d}}_{p , j , {U}_{p}} ) & ( 13 )\end{matrix}$$

\tilde{v}_{p,m,s} is transformed to v_{p,m,s} using the following formula.

$${v}_{p , m , s} = {\sum }_{e = {L}_{p}}^{{U}_{p}} {q}_{p , e} {\tilde{v}}_{p , m , s , e} \\ ∀ p = 1 , 2 , … , P , m = 1 , 2 , … , M , s = 1 , 2 , … , T , \qquad ( 14 )$$

where q_{p,e}, p=1,2, . . . ,P, e=Lₚ,Lₚ+1, . . . ,Uₚ is defined in (1). From transformation formula (14), the mean μ(b_{p,s}) and the variance σ(b_{p,s}) of b_{p,s} are calculated as

$$\begin{matrix}μ ( {v}_{p , m , s} ) = {\sum }_{e = {L}_{p}}^{{U}_{p}} {q}_{p , e} μ ( {\tilde{v}}_{p , m , s , e} ) \\ and & ( 15 ) \\ σ ( {v}_{p , m , s} ) = {\sum }_{e = {L}_{p}}^{{U}_{p}} {q}_{p , e}^{2} σ ( {\tilde{v}}_{p , m , s , e} ) & ( 16 )\end{matrix}$$

The output 130 includes values of binary variables X_{p,t}, p=1,2, . . . ,P, t=1,2, . . . ,T, and Yₚ, p=1,2, . . . ,P. X_{p,t} equals 1 if project p is selected and start at time t, 0 otherwise. Yₚ equals 1 if project p is selected, 0 otherwise.

Next, the system creates the constraint set, which contains the following constraints:

$$\begin{matrix}{\sum }_{t = 1}^{T} {X}_{p , t} = {Y}_{p} ∀ p & ( 17 ) \\ {\sum }_{p = 1}^{P} {\sum }_{s = 1}^{{U}_{p}} {c}_{p , r , s} {X}_{p , t - s + 1} \leq {H}_{r , t} ∀ r , t & ( 18 ) \\ {β}_{j , t} = {G}_{j , t} + {β}_{j , t - 1} - {\sum }_{p = 1}^{P} {\sum }_{s = 1}^{{U}_{p}} {d}_{p , j , s} {X}_{p , t - s - 1} ∀ j , t & ( 19 ) \\ {β}_{j , 0} = 0 ∀ j & ( 20 ) \\ {β}_{j , t} \geq 0 ∀ j , t & ( 21 )\end{matrix}$$

Constraint (17) ensures that a project will be selected at most once. Constraint (18) guarantees that the amount of renewable resource, of each type, allocated to all selected projects cannot exceed the available amount, at any time period t. The continuous variable β_{j,t} in constraint (19) tracks the amount of available consumable resource, of each type, at any time period t, with the initial value of β_{j,0} set to zero as in (20). Constraint (21) ensures that the allocated consumable resource, of each type, at any time period t, never exceeds the available amount.

Budget can be treated as either a renewable or a consumable resource. If the user desires to treat it as a renewable resource, then the following constraint is added to the constraint set

$${\sum }_{p = 1}^{P} {\sum }_{s = 1}^{{U}_{p}} {a}_{p , s} {X}_{p , t - s + 1} \leq {E}_{t} ∀ t \qquad ( 22 )$$

If the user desires to treat budget as a consumable resource, then the following constraints are added to the constraint set

$$\begin{matrix}{z}_{t} = {E}_{t} + {z}_{t - 1} - {\sum }_{p = 1}^{P} {\sum }_{s = 1}^{{U}_{p}} {a}_{p , s} {X}_{p , t - s - 1} ∀ t & ( 23 ) \\ {z}_{0} = 0 & ( 24 ) \\ {z}_{t} \geq 0 ∀ t & ( 25 )\end{matrix}$$

where zₜ tracks the amount of budget that remains unused at the end of each time period t.

A user may specify a precedence relation between projects. These inputs are grouped into “Project Precedence Relation” 110k category. A precedence relation between project \tilde{p} and project p, which insists that project \tilde{p} can not start before project p finishes may be expressed as

$${X}_{\tilde{p} , t} \leq {\sum }_{τ = 1}^{t - {S}_{p}} {X}_{p , τ} ∀ t \qquad ( 26 )$$

A user can specify any number of precedence relations between different project pairs. For each such a relation specified, a constraint like (26) is added to the constraint set.

A user may specify rules that identify logic relations between projects. These rules are grouped into “Logic Rules” 1101 input category. Three types of logic rules are allowed: mutual exclusion, dependency, and mutual dependency. If a mutual exclusion rule for projects p and \tilde{p} (i.e., one can select either one or none of them, but not both) is specified, then the following constraint is added to the existing constraint set,

Yₚ+Y_{\tilde{p}}≦1. (27)

If a dependency rule, which insists that project p cannot be chosen unless project \tilde{p} is chosen, is specified, the following constraint is added to the existing constraint set,

Yₚ−Y_{\tilde{p}}≦0. (28)

If a mutual dependency rule, which insists that project p and project \tilde{p} need to be either chosen together in the portfolio, or not chosen at all, is specified, the following constraint is added to the existing constraint set,

Yₚ−Y=0. (29)

For each of the three types of logic rules, a user may specify any number of such rules. For each such a rule specified, a constraint like (27), or (28), or (29) is added to the constraint set.

A user may specify a lower and/or upper bound a metric should achieve during a certain period. These inputs are grouped into “Portfolio Metric Bounds” 110m category. For a metric m, the user inputs a lower bound LBₘ, and/or an upper bound UBₘ, the starting time period st and the ending time period et, then a constraint like the following is constructed,

$${LB}_{m} \leq {\sum }_{s = st}^{et} {\sum }_{p = 1}^{P} {v}_{p , m , s} {Y}_{p} \leq {UB}_{m} \qquad ( 30 )$$

A user may specify a lower and/or upper bound for each metric and multiple starting-ending time combinations. For each such a bound specified, a constraint like (30) is added to the constraint set.

A user may specify rules that set the minimum (or the maximum, or the exact) amount of budget (or a renewable resource, or a consumable resource) allocated to a certain subset of projects. An example is “at least 20% of the total budget should be allocated to business transformation projects.” This type of rules is grouped into “Type-1 Rules” 110n category. For each such a rule, a user first identifies a subset of projects that this rule targets by inputting p binary indicators φₚ, p=1,2, . . . ,P, where φₚ=1 if this rule targets project p, otherwise, φₚ, =0; then inputs a number, K₁, which represents the minimum (or the maximum, or the exact) amount of budget (or a renewable resource, or a consumable resource) allocated to the identified subset of projects. In the above example, if project p is a “business transformation” project, φₚ=1, otherwise, φₚ=0; and “20% of the budget” is the number K₁. This type of rules are mapped into the following constraint

$${\sum }_{p = 1}^{P} {φ}_{p} {Y}_{p} \{ {\sum }_{s = 1}^{{U}_{p}} {a}_{p , s} / {\sum }_{s = 1}^{{U}_{p}} {c}_{p , r , s} / {\sum }_{s = 1}^{{U}_{p}} {d}_{p , j , s} \} \{ \geq / \leq /= \} {K}_{1} \qquad ( 31 )$$

Depending on the user's inputs, components separated by “/” within the brackets are chosen to generate a concrete rule to add to the constraint set. For example, if the rule is about budget,

$${\sum }_{s = 1}^{{U}_{p}} {a}_{p , s}$$

will be chosen; if the rule is about renewable resource,

$${\sum }_{s = 1}^{{U}_{p}} {c}_{p , r , s}$$

will be chosen; if the rule sets up a minimum threshold, “≧” will be chosen; and if a rules sets up a maximum threshold, “≦” will be chosen, and so on. (Through out this document, brackets and “/” are used to represent possible mutations of a rule that are dependent on user inputs.)

A user can specify arbitrary number of such rules. For each rule specified, a constraint like (31) is added to the constraint set.

A user may specify rules that set the minimum (or the maximum, or the exact) fraction of budget (or return, or a metric, or a renewable resource, or a consumable resource) a certain subset of projects should contribute to the selected portfolio. Such rules are grouped into “Type-2 Rules” 110o category. Let φₚ and 0≦K₂≦1 denote the project indicators and the fraction number user inputs, then such a rule can be mapped into the following constraint

$${\sum }_{p = 1}^{P} {φ}_{p} {Y}_{p} \{ {\sum }_{s = 1}^{{U}_{p}} {a}_{p , s} / {\sum }_{s = 1}^{T} {b}_{p , s} / {\sum }_{s = 1}^{T} {v}_{p , m , s} / {\sum }_{s = 1}^{{U}_{p}} {c}_{p , r , s} / {\sum }_{s = 1}^{{U}_{p}} {d}_{p , j , s} \} \\ \{ \geq / \leq /= \} {K}_{2} {\sum }_{p = 1}^{P} {Y}_{p} \{ {\sum }_{s = 1}^{{U}_{p}} {a}_{p , s} / {\sum }_{s = 1}^{T} {b}_{p , s} / {\sum }_{s = 1}^{T} {v}_{p , m , s} / {\sum }_{s = 1}^{{U}_{p}} {c}_{p , r , s} / {\sum }_{s = 1}^{{U}_{p}} {d}_{p , j , s} \} \qquad ( 32 )$$

A user may specify an arbitrary number of such rules. For each rule specified, a constraint like (32) is added to the constraint set.

A user may specify rules that set the minimum (or the maximum, or the exact) average value of budget (or return, or a metric, or a renewable resource, or a consumable resource) a certain subset of projects should achieve. Such rules are grouped into “Type-3 Rules” 110p category. Let φₚ and K₃ denote the project indicators and the average value user inputs, then such a rule can be mapped into the following constraint

$${\sum }_{p = 1}^{P} {φ}_{p} {Y}_{p} \{ {\sum }_{s = 1}^{{U}_{p}} {a}_{p , s} / {\sum }_{s = 1}^{T} {b}_{p , s} / {\sum }_{s = 1}^{T} {v}_{p , m , s} / {\sum }_{s = 1}^{{U}_{p}} {c}_{p , r , s} / {\sum }_{s = 1}^{{U}_{p}} {d}_{p , j , s} \} \\ \{ \geq / \leq /= \} {K}_{3} {\sum }_{p = 1}^{P} {φ}_{p} {Y}_{p} \qquad ( 33 )$$

A user may specify an arbitrary number of such rules. For each rule specified, a constraint like (33) is added to the constraint set.

A user may specify rules that indicates the minimum (or the maximum, or the exact) number of projects selected from a certain subset of projects. Such rules are grouped into “Type-4 Rules” 110q category. Let φₚ and K₄ denote the project indicators and the threshold number user inputs, then such a rule can be mapped into the following constraint

$${\sum }_{p = 1}^{P} {φ}_{p} {Y}_{p} \{ \geq / \leq /= \} {K}_{4} \qquad ( 34 )$$

A user may specify an arbitrary number of such rules. For each rule specified, a constraint like (34) is added to the constraint set.

Beside the set of constraints constructed based on user inputs, a user may also specify an objective to optimize. An objective is a weighted sum of multiple objective terms. Each term can be a derived metric, or a derived return, or a derived investment. Inputs related to the objective are grouped into “Objective” 110r category.

A derived metric is the sum of a metric over a given number of periods. To add a derived metric term to the objective, a user first selects a metric m, indicts whether this metric is a high-is-better or a lower-is-better metric, inputs a weight wₘ, the start time st and end time et, then a derived metric term is constructed as

$$\{ + / - \} {w}_{m} {\sum }_{t = st}^{el} {\sum }_{p = 1}^{P} {\sum }_{s = 1}^{T} {v}_{p , m , s} {X}_{p , t - s + 1} \qquad ( 35 )$$

where for a high-is-better metric, “+” will be chosen, and for a lower-is-better metric, “−” will be chosen.

A user may specify an arbitrary number of such terms. For each term specified, an expression like (35) is added to the objective.

A derived return is the sum of expected return over a given number of periods. To add a derived return term to the objective, a user inputs a weight w_{b}, the start time st and end time et, then a derived return term is constructed as

$$+ {w}_{b} {\sum }_{t = st}^{et} {\sum }_{p = 1}^{P} {\sum }_{s = 1}^{T} {b}_{p , s} {X}_{p , t - s + 1} \qquad ( 36 )$$

A user may specify an arbitrary number of such terms. For each term specified, an expression like (36) is added to the objective.

A derived investment is the sum of required investment over a given number of periods. To add a derived investment term to the objective, a user inputs a weight wₐ, the start time st and end time et, then a derived return term is constructed as

$$- {w}_{a} {\sum }_{t = st}^{et} {\sum }_{p = 1}^{P} {\sum }_{s = 1}^{{U}_{p}} {a}_{p , s} {X}_{p , t - s + 1} \qquad ( 37 )$$

A user may specify an arbitrary number of such terms. For each term specified, an expression like (37) is added to the objective.

To summarize, a mathematical optimization problem is constructed with an objective and a set of constraints. The objectives are constructed by summing up terms, for example, (35), (36), and (37). The constraints may include constraints (17)-(34). The constructed problem is solved as follows.

Constraints (18), (19), (21), (22), (23), (25), (26), (30), (31), (32), (33) and (34) involve random quantities. They are called soft constraints, which should be satisfied with a high probability. Note that except constraint (26), all other soft constraints can be written in the following general form

aᵢx₁+a₂x₂+ . . . +aₙxₙ≦b, (38)

where a i=1,2, . . . n, are independent random quantities, xᵢ, i=1,2, . . . n, are 0-1 decision variables, and b is a deterministic number.

The system transforms soft constraints like (38) that involve random quantities to hard ones that do not. To do so, the system/method uses an input that specifies a threshold probability that the user requires constraints like (38) to hold. For example, an input 0.9 means that the user requires a constraint like (38) to hold with at least 90% of probability. This input is denoted as h, which essentially reflects the user's risk attitude. Given the input h, a soft constraint like (38) can be replaced by the following three hard constraints

$$\begin{matrix}μ ( {a}_{1} ) {x}_{1} + μ ( {a}_{2} ) {x}_{2} + … + μ ( {a}_{n} ) {x}_{n} \leq b & ( 39 ) \\ {( {Φ}^{- 1} ( h ) )}^{2} ( σ ( {a}_{1} ) {x}_{1} + σ ( {a}_{2} ) {x}_{2} + … + σ ( {a}_{n} ) {x}_{n} ) \leq {b}^{2} + {\sum }_{i = 1}^{n} {( μ ( {a}_{i} ) )}^{2} {x}_{i} - 2 b {\sum }_{i = 1}^{n} μ ( {a}_{i} ) {x}_{i} + 2 {\sum }_{i > j}^{n} {\sum }_{j = 1}^{n} μ ( {a}_{i} ) μ ( {a}_{j} ) {w}_{i , j} & ( 40 ) \\ {w}_{i , j} \geq {x}_{i} + {x}_{j} - 1 \\ {w}_{i , j} \leq {x}_{i} \\ {w}_{i , j} \leq {x}_{j} \\ {w}_{i , j} ∈ \{ 0 , 1 \} & ( 41 )\end{matrix}$$

where μ(aᵢ) and σ(aᵢ) are the mean and the variance of random quantity aᵢ respectively (note that μ(aᵢ) and σ(aᵢ) are known for any random quantities, as they are part of user's inputs); φ⁻¹(·) is the inverse cumulative distribution function of the standard normal distribution; and w_{i,j} are automatically generated auxiliary 0-1 variables. This transformation is applied to constraints (18), (19), (21), (22), (23), (25), (30), (31), (32), (33) and (34) to transfer them to hard ones. All the threshold probabilities h 's that user inputs are grouped into “Risk attitudes” category 110s.

For constraint (26), the user inputs a threshold probability that indicates the minimum chance such a constraint will hold. This probability is denoted as f and is also grouped into the “Risk Attitudes” category 110s. Based on f, a minimum integer Iₚ such that the probability of project p finishing within Iₚ periods is greater than f is determined, i.e.,

$${I}_{p} = min \{ I \vert {\sum }_{e = {L}_{p}}^{I} {q}_{p , e} \geq f \} .$$

Once Iₚ is determined, constraint (26) is replaced by the hard constraint

$${X}_{\tilde{p} , t} \leq {\sum }_{τ = 1}^{t - {I}_{p}} {X}_{p , τ} ∀ t \qquad ( 42 )$$

All the soft constraints now have been transformed to hard ones. Next, the system/method handles random quantities in the objective. It is a sum of terms like (35), (36) and (37), and can be rewritten in the following general form,

c₁x₁+c₂x₂+ . . . +cₙxₙ (43)

where cᵢ, i=1,2, . . . n, are random coefficients.

The method/system uses three possible approaches. The first approach, which is the simplest one, transforms (43) to

μ(c₁)x₁+μ(c₂)x₂+ . . . +μ(cₙ)xₙ (44)

The second approach asks the user to input a bound g on the variance of the random objective, and then transfers the objective to (44) and add the following new constraint to the constraint set

The third approach asks the user to input a bound k on the coefficient of variation of the random objective, and then transfers the objective to (44) and add the following constraints to the constraint set,

$$\begin{matrix}σ ( {a}_{1} ) {x}_{1} + σ ( {a}_{2} ) {x}_{2} + … + σ ( {a}_{n} ) {x}_{n} \leq {k}^{2} {\sum }_{i = 1}^{n} {( μ ( {c}_{i} ) )}^{2} {x}_{i} + 2 {k}^{2} {\sum }_{i > j}^{n} {\sum }_{j = 1}^{n} μ ( {c}_{i} ) μ ( {c}_{j} ) {w}_{i , j} & ( 46 ) \\ {w}_{i , j} \geq {x}_{i} + {x}_{j} - 1 \\ {w}_{i , j} \leq {x}_{i} \\ {w}_{i , j} \geq {x}_{j} \\ {w}_{i , j} ∈ \{ 0 , 1 \} & ( 47 )\end{matrix}$$

where w_{i,j} are generated auxiliary 0-1 variables.

User's inputs of g or h are grouped into “Risk Attitudes” category 110s as well.

An integer programming problem with all deterministic parameters is now obtained. An existing solver, for example COIN-OR, can be used to solve such a problem.

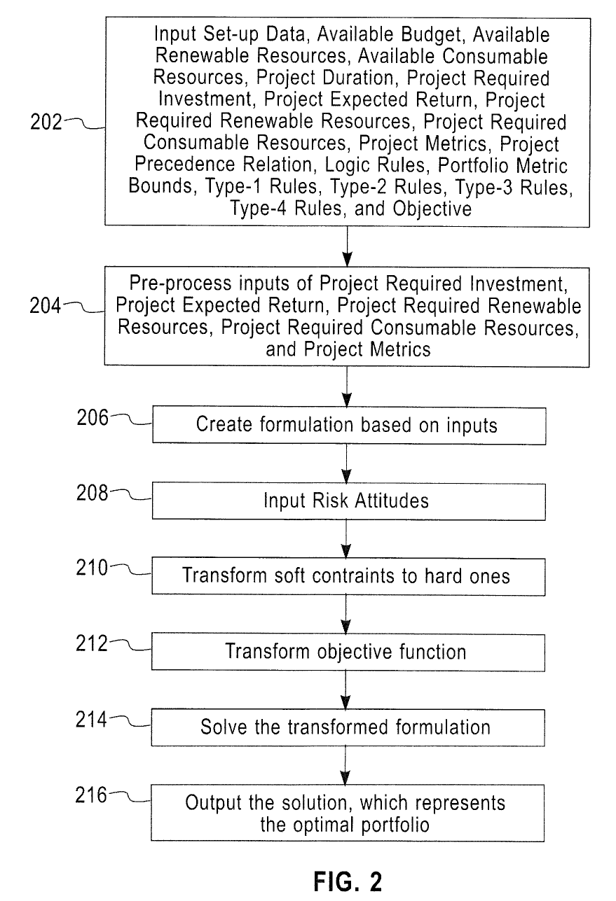

FIG. 2 illustrates an optimization method 200 in accordance with an exemplary, non-limiting embodiment of the present invention. The method inputs 202 at least one of (in some instances all of) Set-up Data, Available Budget, Available Renewable Resources, Available Consumable Resources, Project Duration, Project Required Investment, Project Expected Return, Project Required Renewable Resources, Project Required Consumable Resources, Project Metrics, Project Precedence Relation, Logic Rules, Portfolio Metric Bounds, Type-1 Rules, Type-2 Rules, Type-3 Rules, Type-4 Rules, and Objective.

The inputs of Project Required Investment, Project Expected Return, Project Required Renewable Resources, Project Required Consumable Resources, and Project Metrics are pre-processed 204.

Next, a formulation is created 206 that has multiple constraints and a single objective function based on the inputs.

Then, the Risk Attitudes are input 208.

The soft constraints are transformed 210 in the formulation to hard ones. If the objective function involves random quantities, then the objective function is also transformed 212.

The transformed formulation is solved 214 using an integer programming solver and the solution, which represents the optimal portfolio, is output 216.

The above explanation is merely for illustration, and is not meant to limit the scope of the claimed invention. The procedures explained above can be changed as far as at the end the same deterministic integer programming problem is generated. For example, one can change the order in which the method/system accepts inputs, transforms soft constraints to hard ones immediately after they are inputted, transforms random objective before constraints, etc. These changes will not affect the final output.

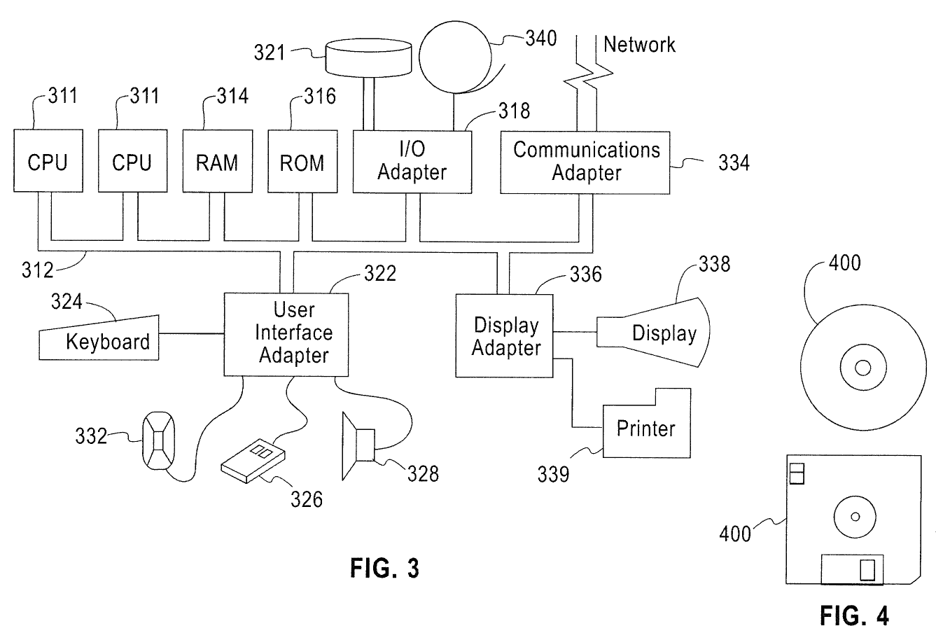

FIG. 3 illustrates a typical hardware configuration of an information handling/computer system in accordance with the invention and which preferably has at least one processor or central processing unit (CPU) 311.

The CPUs 311 are interconnected via a system bus 312 to a random access memory (RAM) 314, read-only memory (ROM) 316, input/output (I/O) adapter 318 (for connecting peripheral devices such as disk units 321 and tape drives 340 to the bus 312), user interface adapter 322 (for connecting a keyboard 324, mouse 326, speaker 328, microphone 332, and/or other user interface device to the bus 312), a communication adapter 334 for connecting an information handling system to a data processing network, the Internet, an Intranet, a personal area network (PAN), etc., and a display adapter 336 for connecting the bus 312 to a display device 338 and/or printer 339 (e.g., a digital printer or the like).

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable (e.g., computer readable) instructions. These instructions may reside in various types of signal-bearing (e.g., computer readable) media.

Thus, this aspect of the present invention is directed to a programmed product, comprising signal-bearing (e.g., computer readable) media tangibly embodying a program of machine-readable (e.g., computer readable) instructions executable by a digital data processor incorporating the CPU 311 and hardware above, to perform the method of the invention.

This signal-bearing media may include, for example, a RAM contained within the CPU 311, as represented by the fast-access storage for example. Alternatively, the instructions may be contained in another signal-bearing media, such as a magnetic data storage diskette 400 (FIG. 4), directly or indirectly accessible by the CPU 311.

Whether contained in the diskette 400, the computer/CPU 311, or elsewhere, the instructions may be stored on a variety of machine-readable (e.g., computer readable) data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing (e.g., computer readable) media. Additionally, signal-bearing media (e.g., computer readable) may include transmission media such as digital and analog and communication links and wireless. In an illustrative embodiment of the invention, the machine-readable (e.g., computer readable) instructions may comprise software object code.

While the invention has been described in terms of several exemplary embodiments, those skilled in the art will recognize that the invention can be practiced with modification.

Further, it is noted that, Applicant's intent is to encompass equivalents of all claim elements, even if amended later during prosecution.

What is claimed is:

1. A portfolio generating system, comprising:
a portfolio optimizing unit configured to generate a balanced portfolio.

2. The system according to claim 1, further comprising a parameter input unit that inputs parameters that affect a portfolio decision.

3. The system according to claim 2, wherein the parameters comprise at least one of project candidates, multiple-user defined objectives, preference order, balancing rules, multiple user-defined business compliance rules, and resources availability.

4. The system according to claim 3, wherein the project candidates comprise at least one of metric values, classification identifications, and resource consumption values.

5. The system according to claim 3, wherein the multiple-user defined objectives comprise a summary of weighted, time-phased metrics values of projects.

6. The system according to claim 3, wherein the portfolio optimizing unit balances a plurality of objectives according to the preference order, and the balancing rules.

7. A method of generating a portfolio, comprising:
optimizing input parameters to generate an optimized portfolio.

8. The method according to claim 7, further comprising:
defining set-up data; and
submitting project proposals,
wherein said optimizing is conducted based on the set-up data and the project proposals.

9. The method according to claim 8, wherein the set-up data comprises at least one of project candidates, multiple-user defined objectives, preference order, balancing rules, multiple user-defined business compliance rules, and resources availability.

10. The method according to claim 9, wherein said optimizing comprises balancing a plurality of objectives according to the preference order and the balancing rules.

11. The method according to claim 7, wherein said optimizing comprises:
inputting parameters, said parameters comprising at least one of set-up data, available budget, available renewable resources, available consumable resources, project duration, project required investment, project expected return, project required renewable resources, project required consumable resources, project metrics, project precedence relation, logic rules, portfolio metric bounds, balancing rules, multiple user-defined business rules, and objectives;
pre-processing the parameters;
creating a formulation that has multiple constraints and a single objective function;
inputting risk attitudes;
transforming soft constraints in the formulation to hard constraints based on the risk attitudes;
transforming the objective function; and
solving the formulation to find an optimized portfolio.

12. The method according to claim 11, wherein said parameters comprise set-up data, available budget, available renewable resources, available consumable resources, project duration, project required investment, project expected return, project required renewable resources, project required consumable resources, project metrics, project precedence relation, logic rules, portfolio metric bounds, balancing rules, multiple user-defined business rules, and objectives.

13. The method according to claim 11, wherein said setup data comprises a maximum number of time periods in a planning horizon, a number of projects to consider, a number of user-defined metrics, a number of user-defined renewable resources, and a number of user-defined consumable resources.

14. The method according to claim 11, wherein said inputting parameters comprises inputting the available budget, the available amount of each user-defined renewable resource, and the available amount of each user-defined consumable resource in each time period in a planning horizon.

15. The method according to claim 14, wherein said project duration comprises the duration of each project.

16. The method according to claim 11, wherein inputting parameters comprises inputting a conditional required investment, a conditional expected return, a conditional required amount of each user-defined renewable source, a conditional required amount of each user-defined consumable resource, and a conditional metric value of each user-defined metric, for each project in each time period during its time-span.

17. The method according to claim 11, wherein inputting parameters comprises inputting a precedence relation between projects, logic relations between projects, a lower bound and an upper bound imposed on user-defined metrics, balancing rules, and multiple user-defined business rules.

18. The method according to claim 11, wherein said object comprises a weighted sum of multiple terms, each term comprises a derived metric, a derived return, or a derived investment.

19. The method according to claim 11, wherein solving the transformed formulation comprises invoking an integer programming solver to solve the transformed problem to find the optimized portfolio.

20. A computer-readable medium tangibly embodying a program of computer-readable instructions executable by a digital processing apparatus to perform a method of generating a portfolio, said method comprising:
optimizing input parameters to generate a balanced portfolio.
